(19) United States
(12) Patent Application Publication
(10) Pub. No.: US 2009/0096955 A1
(43) Pub. Date: Apr. 16, 2009

(54) Liquid Crystal Display Appliance and Lighting System

(76) Inventors: Akitoyo Konno, Hitachi (JP); Yoshifumi Sekiguchi, Hitachiota (JP); Makoto Tsumura, Hitachi (JP); Ikuo Hiyama, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/251,477

(22) Filed: Oct. 15, 2008

(30) Foreign Application Priority Data
Oct. 15, 2007 (JP) 2007-267763

(51) Int. Cl. G02F 1/13357

(52) U.S. Cl. 349/64; 362/97.2

(57) ABSTRACT

The present invention provides a liquid crystal display appliance in which portions of a liquid crystal display panel over luminescent lamps are not seen extraordinarily brighter and brightness of the liquid crystal display panel does not lower significantly at portions in the vicinity of the vertical direction edge of the liquid crystal display panel if a lighting system becomes thinner than 20 mm. This liquid crystal display appliance comprises a lighting system, in which a distance D between light reflector sheet 5 and a light diffuser plate 11 is between 7 and 13 mm, the distance D and an interval p between 2 adjacent luminescent lamps satisfy an inequality, p≦1.34×D+9, and the distance D and a length e between a boundary between an upper edge surface 6a and an inclined surface 5b of the light diffuser plate 11 and a nearest luminescent lamp from the boundary satisfy another inequality, e≦1.6×D+4.

### CROSS REFERENCE TO RELATED APPLICATIONS

The present application claims the benefit under 35 U.S.C. 119 of Japanese Patent Application 2007-267763 filed on Oct. 15, 2007, the disclosure of which is incorporated in this application by reference.

### BACKGROUND OF THE INVENTION

1. Field of the Invention

The present invention relates to miniaturization of the liquid crystal display appliance and making thin the lighting system used for a backlight of the liquid crystal display appliance.

2. Description of the Related Art Japanese Laid-open Patent Application 2005-347062 discloses a liquid crystal display appliance (referred to as “LCD appliance” hereinafter) equipped with a lighting system emitting white light onto a liquid crystal display panel (referred to as “LCD panel” hereinafter), which is attached on the back side of the liquid crystal display panel. This lighting system comprises a plurality of fluorescent lamps and a light reflector member for diffusing and reflecting the white light from the fluorescent lamps which is disposed on the back side of the fluorescent lamps and a light diffusing plate for diffusing and transmitting the white light from the fluorescent lamps which is disposed in front of the fluorescent lamps.

If a lighting system used in the aforesaid conventional LCD appliance is made thin to miniaturize a LCD appliance, there come up problems with brightness inhomogeneity on a LCD panel. One of the problems is that a portion of a LCD panel over each luminescent lamp is seen brighter than portions of the LCD panel over between adjacent lamps if the lighting system becomes thin. Accordingly the brightness of a portion in the LCD panel is dependent on whether the portion is over any of the luminescent lamps. The LCD appliance becomes defective because the portions of a LCD panel over the luminescent lamps are seen brighter than the other portions.

The other problem with the thinner lighting system for the aforesaid conventional LCD appliance is that the brightness distribution is not sufficiently homogeneous over a whole LCD panel as shown in FIG. 10. FIG. 10 indicates a brightness distribution in the vertical direction of a LCD panel in the aforesaid conventional LCD appliance. In this brightness distribution in FIG. 10, the brightness is lower significantly in the vicinity of each vertical direction edge in the LCD panel than in the center portion of the LCD panel. The LCD appliance with the brines distribution as indicated by FIG. 10 is defective because the portion in the vicinity of each vertical direction edge in the LCD panel is seen darker than the portion in the vicinity of the center of the LCD panel.

### SUMMARY OF THE INVENTION

The objective of the present invention is to provide a LCD appliance capable of displaying a good picture image without any recognizable brightness irregularity if its lighting system is made thin.

The aspect of the present invention is that a LCD appliance comprising a LCD panel for displaying a picture image and a lighting system for emitting light incident onto the LCD, the lighting system being attached on a back side of the LCD panel and comprising a plurality of linearly elongated light sources each of which is disposed in substantially parallel with a display horizontal direction of the LCD panel, a light reflector member for reflecting the light emitted from the linearly elongated light sources as well as diffusing the light, the light reflector member disposed on a back side of the linearly elongated light sources, and a light diffusing-transmission member for transmitting and diffusing the light, the light diffusing-transmission sheet disposed in front of the linearly elongated light sources, wherein a length D between the light reflector member and the light diffusing-transmission member is between 7 and 13 mm, wherein a length p between the adjacent linearly elongated light sources and the distance D satisfy an first inequality, p≦1.34×D+9, and wherein a length e between a vertical direction edge of the light reflector member and a nearest linearly elongated light source from the vertical direction edge and the length D satisfy a second inequality, e≦1.6×D+4.

### BRIEF DESCRIPTION OF THE DRAWINGS

FIG. 1 is an exploded view showing a design of a LCD appliance according to an embodiment of the present invention.

FIG. 2 is a cross sectional view of a LCD appliance according to an embodiment of the present invention, which shows a design of the LCD appliance.

FIG. 3 is a cross sectional view of a LCD appliance according to an embodiment of the present invention when cut out along A-A line in FIG. 2, which shows a design of the LCD appliance.

FIG. 4 is a figure showing the layout design of the luminescent lamps in a LCD appliance according to an embodiment of the present invention.

FIG. 5 is a perspective view of a concavo-convex patterned light diffusing plate.

FIG. 6 shows a brightness distribution in the vertical direction of a LCD panel measured on a LCD appliance according to an embodiment of the present invention.

FIG. 7 indicates the condition of experiments to obtain optimum intervals between 2 adjacent luminescent lamps 2, with which the brightness irregularity is sufficiently prevented on a LCD panel of the LCD appliance according to an embodiment of the present invention.

FIG. 8 shows results on experiments to obtain optimum intervals between 2 adjacent luminescent lamps 2 and lengths between a vertical direction edge of the backlight unit and a nearest luminescent lamp, to prevent the brightness irregularity of a LCD panel of the LCD appliance according to an embodiment of the present invention.

FIG. 9 indicates the condition of experiments to obtain lengths between a vertical direction edge of the backlight unit and a nearest luminescent lamp, with which the brightness irregularity is sufficiently prevented on a LCD panel of the LCD appliance according to an embodiment of the present invention.

FIG. 10 is a brightness distribution in the vertical direction of a LCD panel in the conventional LCD appliance.

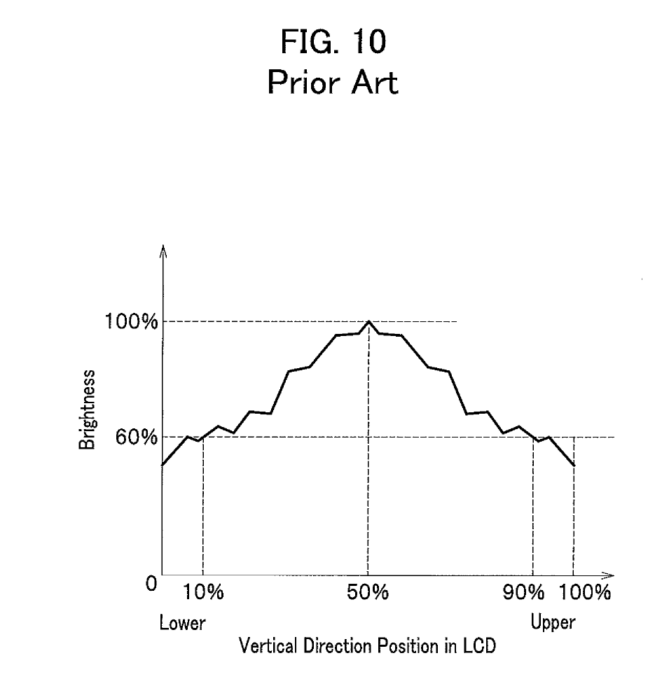

### DETAILED DESCRIPTION OF THE EXEMPLARY EMBODIMENT OF THE INVENTION

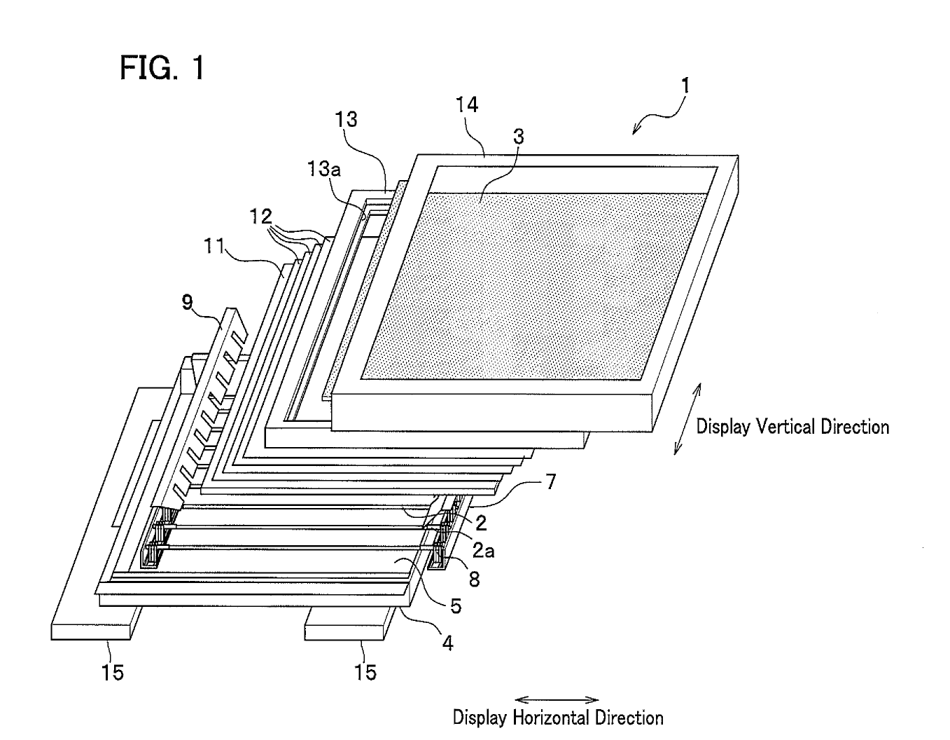

An explanation is hereinafter given on the LCD appliance that is in accordance with an embodiment of the present invention. To begin with, taking a look at FIG. 1 to FIG. 4, the design of the LCD appliance of the embodiment is to be explained.

A LCD appliance 1 of the embodiment comprises 9 luminescent lamps and a LCD panel 3 that displays a picture image. Each of the luminescent lamps 3 is in a linearly elongated shape and emits identical white light which comes incident onto the LCD panel 3 as backlighting. The number of the luminescent lamps in the LCD appliance 1 of this embodiment is 9 and not limited to 9. As long as the LCD appliance 1 includes a plurality of luminescent lamps, the number of the luminescent lamps in the LCD appliance 1 of this embodiment may be more than 9 or less than 9.

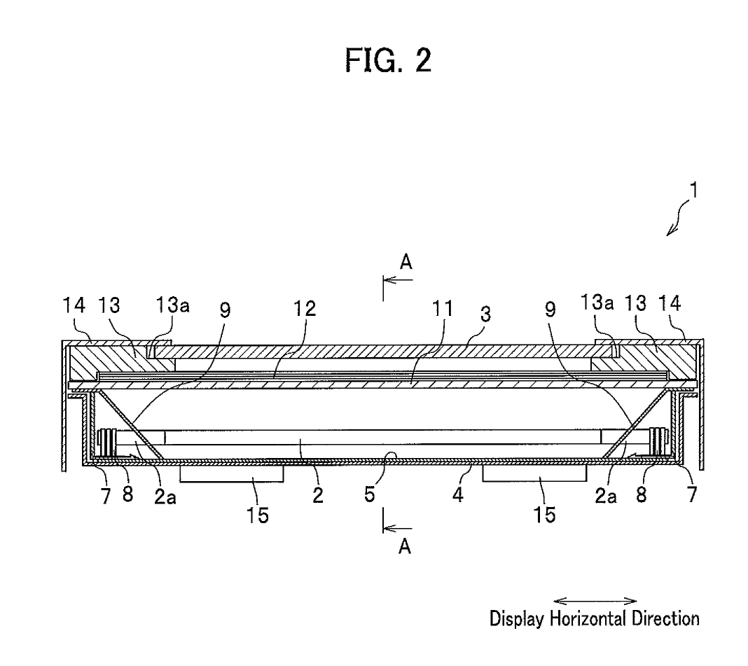

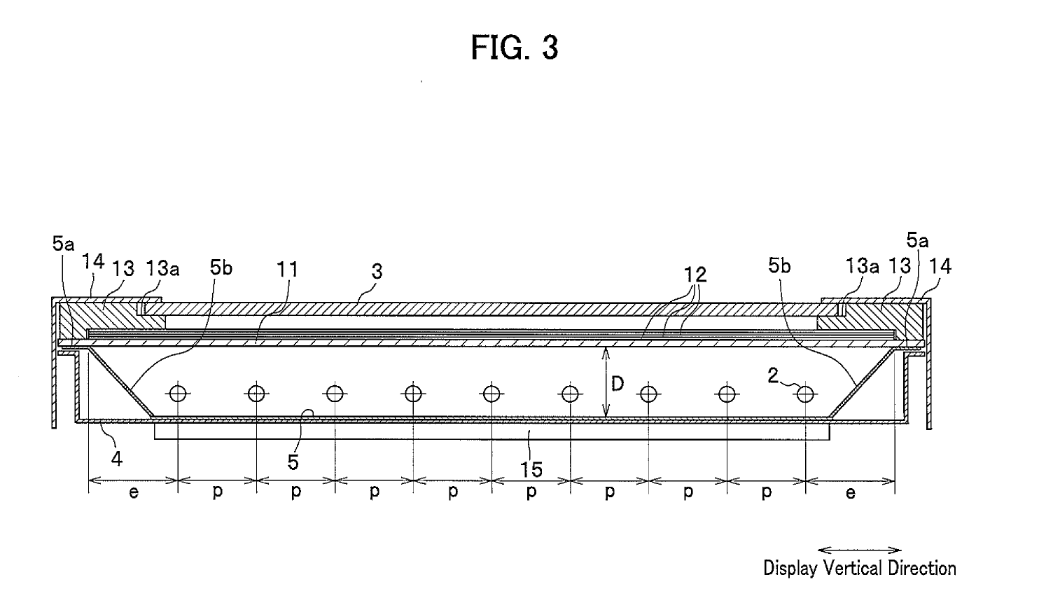

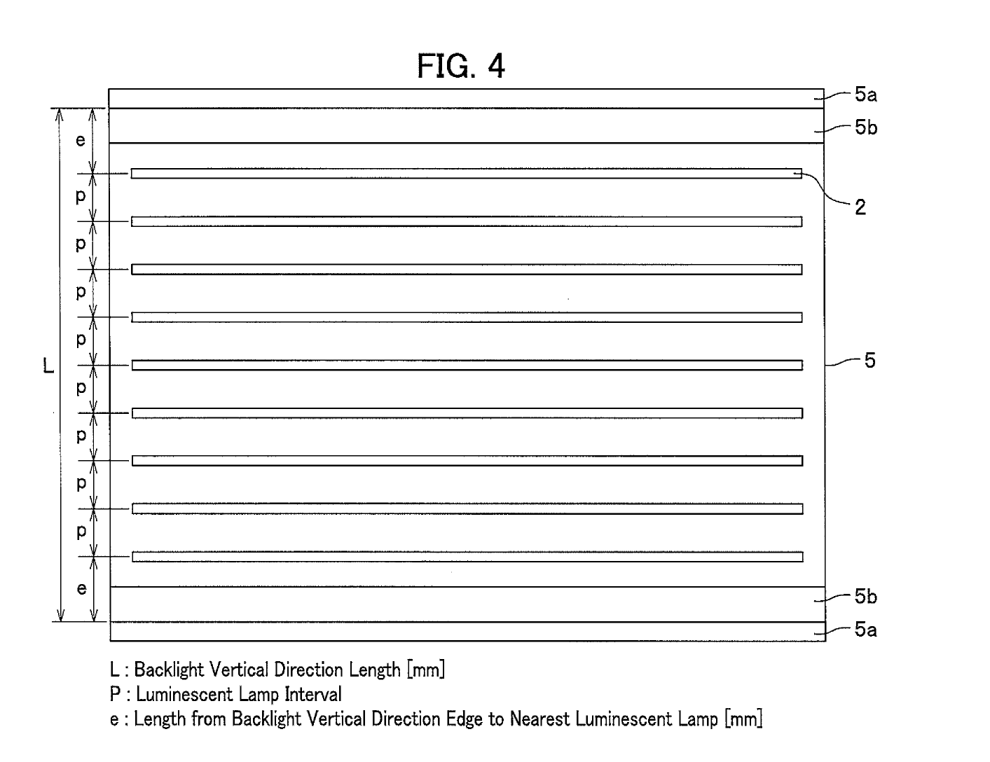

As indicated in FIG. 1 and FIG. 2, each of the luminescent lamps 2 is held by a couple of electrode holders 8 fixed on lower side molds 7 so as to be fixed at a position a predetermined height higher than a light reflector sheet 5 and in parallel with the horizontal direction of the LCD panel 3. The lower side molds 7 are fixed on the light reflector sheet 5 that is attached on a lower frame 4. As is seen in FIG. 3 and FIG. 4, all the luminescent lamps 2 are disposed at a constant interval p and every adjacent lamps are spaced a constant distance p apart from each other. An inverter 15 that drives the luminescent lamps 2 to emit the white light is secured on the back of the lower frame 4 as is shown in FIG. 1 to FIG. 3.

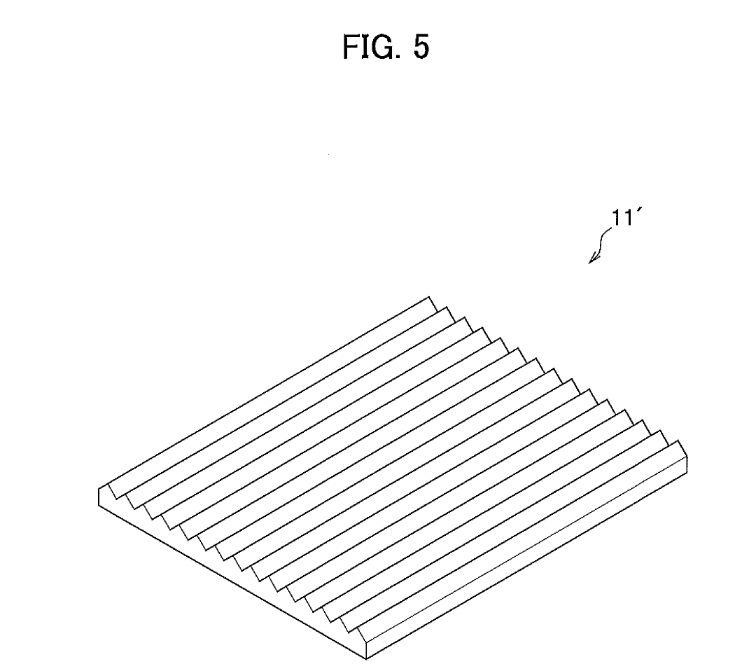

A light diffuser plate 11, on which 4 optical sheets are attached, is supported by upper side molds 9 each of which is disposed to cover up a lower side mold 7 and fixed at a position a predetermined height higher than the light reflector sheet 5. The 4 optical sheets 12 used for the LCD appliance 1 of this embodiment are constituted by a light diffuser sheet, a light collecting film, a light diffuser sheet and a light diffuser sheet which are stacked in this order from on the light diffuser plate 11. The 4 optical sheets 12 may be constituted by a light diffuser sheet, a light collecting film, a light diffuser sheet and a polarizing reflector film, which are stacked in this order from on the light diffuser plate 11 and may constituted by another combination of optical sheets. There may be less than 4 optical sheets stacked on the light diffuser plate 5, more than 4 optical sheets stacked on the light diffuser plates 5. A plurality of optical sheets suffice for constituting the optical sheet 12. According to the LCD appliance 1 of the present embodiment the light diffuser plate 3 has a smooth surface on the side of the LCD panel 3, but the light diffuser plate 3 may have a patterned surface in a concavo-convex shape as indicated in FIG. 5.

A LCD panel 3 is fitted into a groove 13a formed on the inner periphery of an intermediate frame 5 and secured on the intermediate frame 13 with an adhesive. Then the upper frame 14 is fixed on the intermediate frame 13 on which the LCD panel 3 is secured.

Next an explanation is given on the operation of the LCD appliance 1 of the present embodiment.

The white light emitted from the luminescent lamps 2 that comes incident onto the reflector sheet 5 is efficiently diffused and reflected upward on the reflector plate 5 and the white light from the luminescent lamps 2 is diffused in the light diffuser plate 11 and transmitted through the light diffuser plate 11. As a result the white light emitted from the luminescent lamps 5 is transmitted out of the light diffuser plate 11 into the 4 optical sheets 12 attached on the light diffuser plate 11 after being repeatedly transmitted and reflected several times between the light reflector sheet 5 and the light diffuser plate 11. The diffuseness as well as the directivity of the white light is controlled by the 4 optical sheets 12.

Next how bright irregularity on the LCD panel 3 is prevented in the LCD appliance 1 of the present embodiment is explained.

In the LCD appliance 1, the thinner the lighting system consisting of the luminescent lamp 2, the light reflector sheet 5, the light diffuser plate 11, the 4 optical sheets is made, the smaller a distance D from the light reflector sheet 5 to the light diffuser plate 11, which is regarded as a light diffusion distance, becomes. In order to prevent brightness irregularity on the LCD panel 3 for the smaller light diffusion distance D, it is necessary to make a luminescent lamp interval p, which is a length between adjacent luminescent lamps 2 as indicated in FIG. 3 and FIG. 4, smaller than or equal to a predetermined length. In case this luminescent lamp interval becomes larger than the predetermined length, each portion of the LCD panel 3 over the luminescent lamp should be seen brighter and become a defect of brightness irregularity, which has already been mentioned in this description. In the case of the conventional LCD appliances, their lighting system has not been made thinner, as is indicated in the paragraph 0018 in the specification of Japanese Patent No. 3642723 and is as thick as 20 mm and the light diffusion distance is a little smaller than 20 mm. Therefore the conventional LCD appliances do not have any problem with brightness irregularity.

In addition to making the luminescent lamp interval p equal to or smaller than the predetermined length, it is necessary to make a length e from a boundary between an upper edge surface 6a and an inclined surface 5b of the light reflector sheet 5 to a nearest luminescent lamp from this boundary, which is indicated in FIG. 3 and FIG. 4, equal to or smaller than a predetermined length, in order to prevent brightness irregularity on the LCD panel 3. The length e is referred to as the length from the vertical direction edge of the backlight unit to the nearest luminescent lamp from the vertical direction edge or simply to the length e hereinafter. The reason why the inclined surface 5b is formed in the light reflector sheet 5 is that the white light is collectively reflected and directed toward the LCD panel 3, which is disclosed in the specification of Japanese Patent No. 3642723. In case this length e from the vertical direction edge of the backlight unit to the nearest luminescent lamp from the vertical direction edge becomes larger than the predetermined length, there occurs a defect on the LCD panel 3, in which the portion in the vicinity of each vertical direction edge of the LCD panel 3 should be seen darker than the center portion in the vertical direction of the LCD panel 3 because the brightness of the portion in the vicinity of each vertical direction edge of the LCD panel 3 becomes lower than that of the center portion in the vertical direction of the LCD panel 3.

It has been found through experiments by the inventors that both of the luminescent lamp interval p and the length e from the vertical direction edge of the backlight unit to the nearest luminescent lamp from the vertical edge to prevent the brightness irregularity on the LCD panel 3 are dependent on the light diffusion distance D. For each light diffusion distance D both the luminescent lamp interval p and the length e to prevent the brightness irregularity on the LCD panel 3 are obtained. As a result it proves that the brightness irregularity on the LCD panel 3 is efficiently prevented by setting the luminescent lamp interval p and the length e so that p and e satisfy the following inequalities (1) and (2),

p≦1.34×D+9 (1)

e≦1.6×D+4 (2)

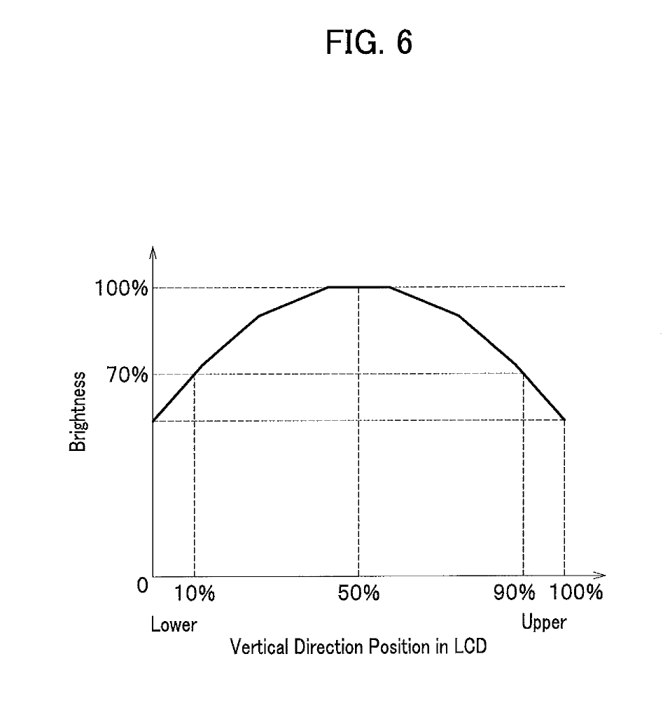

In this description, preventing the brightness irregularity on the LCD panel 3 means preventing the portions over the luminescent lamps of the LCD panel 3 from being seen brighter as well as having brightness on both the position located 10% of the vertical direction length of the LCD panel 3 downward from the vertical direction upper edge on the LCD panel 3 and the position located 10% of the vertical direction length of the LCD panel 3 upward from the vertical direction lower edge being equal to or more than 70% of the brightness of the center portion in the vertical direction of the LCD panel 3, which is consistent with the criteria for LCD panels currently used for television appliances. FIG. 6 shows a brightness distribution in the vertical direction of a LCD panel measured on a LCD appliance according to an embodiment of the present invention with the brightness on the center portion of the LCD panel equal to 100%, which satisfies the above mentioned criteria.

Next are explained experiments carried out to obtain the optimum luminescent lamp intervals and the optimum lengths from a vertical direction edge of the LCD panel to a nearest luminescent lamp from the vertical direction edge.

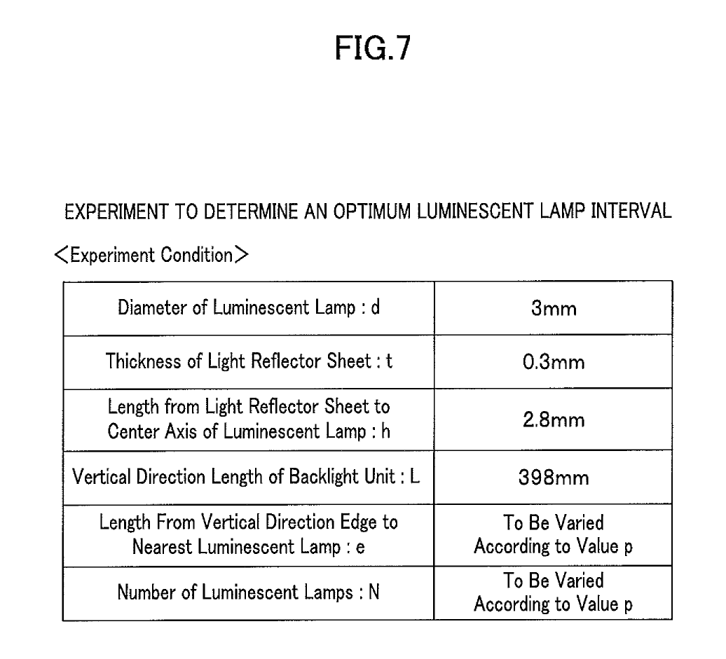

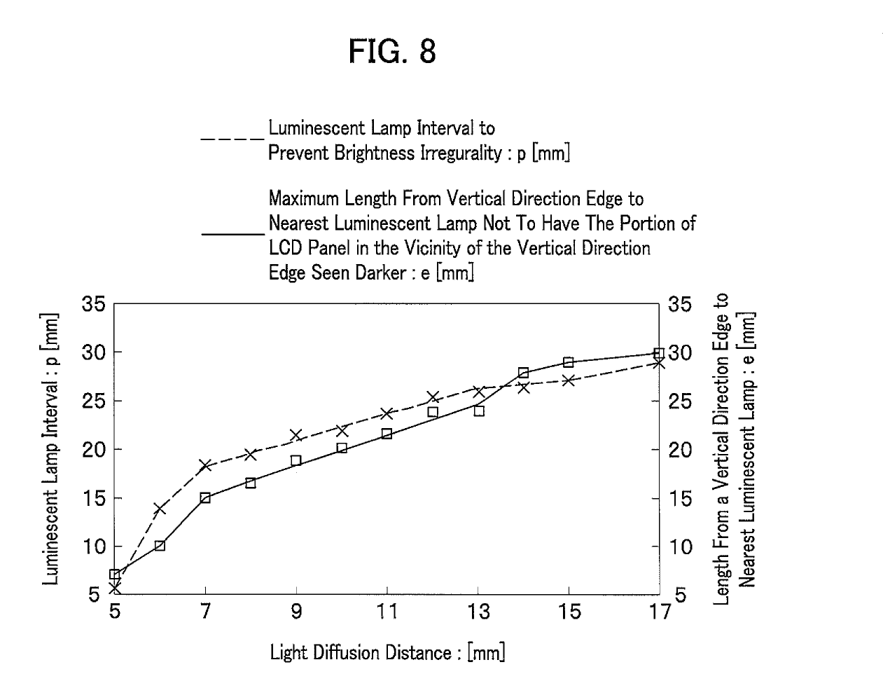

Firstly are explained experiments on the luminescent lamp interval p to prevent the brightness irregularity on the LCD panel 3. These experiments have been carried out to obtain the optimum luminescent lamp intervals p to prevent the brightness irregularity of the LCD panel 3 for each of the light diffusion distances from 5 mm to 17 mm. Accordingly setting the light diffusion distance D to each of 5, 6, 7, 8, 9, 10, 11, 12, 13, 14, 15, 16 and 17 mm, an experiment is carried out to check whether the brightness irregularity is prevented for every light luminescent interval p set. This experiment is repeatedly performed with the light luminescent interval p being varied for each light diffusion distance D set. As a result the largest light luminescent interval p to prevent the brightness irregularity on the LCD panel 3 is obtained for each light diffusion distance D. The experiment condition is indicated in FIG. 7 and the result is shown in FIG. 8. In these experiments the length e and the number of the luminescent lamps N are changed according to the luminescent lamp interval p, because whether there occurs a defect of the portions of the LCD panel 3 over the luminescent lamps 2 being seen extraordinarily brighter is dependent only on the luminescent lamp interval p.

The result in FIG. 8 indicates that if the light diffusion distance D and the luminescent lamp interval p satisfy the inequality (1) for the light diffusion distances between 7 and 13 mm, there is no defect of the portions of the LCD panel 3 over the luminescent lamps being seen extraordinarily brighter.

On the other hand it has been found that the defect of the brightness lowering at the portion in the vicinity of the vertical direction edge of the LCD panel 3 is removed by setting the length e from the vertical direction edge of the backlight unit to the nearest luminescent lamp 2 from the vertical direction edge to the optimum values obtained through experiments to be explained.

Secondly are explained experiments to obtain the optimum lengths e from a vertical direction edge of the backlight unit to the nearest luminescent lamp 2 from the vertical edge to prevent the brightness irregularity on the LCD panel 3

The experiments are carried out as follows. Setting out the light diffusion distance D to each of 5, 6, 7, 8, 9, 10, 11, 12, 13, 14, 15, 16 and 17 mm, an experiment is carried out to check whether the brightness irregularity is prevented for every length e set. This experiment is repeatedly performed with the length e being varied for each light diffusion distance D set. As a result the largest length e from the vertical direction edge of the backlight unit to the nearest luminescent lamp 2 from the vertical edge to prevent the brightness irregularity on the LCD panel 3 is obtained for each light diffusion distance D.

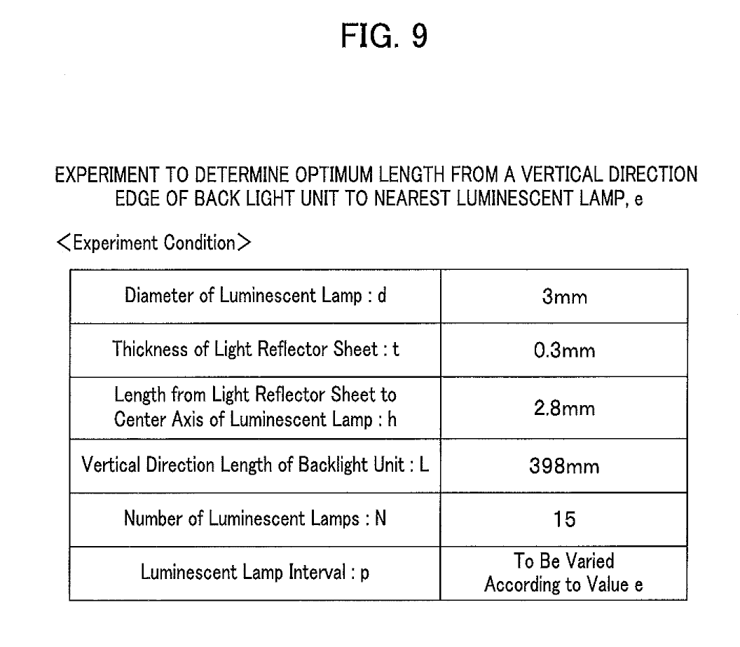

The experiment condition for these experiments is indicated in FIG. 9 and the result is shown in FIG. 8. These experiments have been carried out on the assumption that the luminescent lamp interval p has hardly an influence on the lower brightness on the portion in the vicinity of the vertical direction edge of the LCD panel 3. 15 luminescent lamps are disposed on the back side of a LCD panel 3 with all luminescent lamp intervals p between 2 adjacent luminescent lamps 2 being equal to around 26 mm, in order to reduce the brightness variation in the display vertical direction due to the luminescent lamp interval being varied.

The result in FIG. 8 indicates that if the light diffusion distance D and the length e satisfy the inequality (2) for the light diffusion distances between 7 and 13 mm, there occurs no defect of the brightness lowering at the portions in the vicinity of the vertical direction edges of the LCD panel 3.

As explained above, if the luminescent lamp interval p and the length e are set to satisfy the inequalities (1) and (2), both defects of the portions of the LCD 3 over the luminescent lamps 2 being seen extraordinarily brighter and the brightness lowering at the portions in the vicinity of the vertical direction edges of the LCD panel 3 are removed. Therefore the brightness irregularity of the LCD panel 3 is prevented if the light diffusion distance is decreased from a little less than 20 mm to between 7 and 13 mm.

Hereinafter are explained applications of the present embodiment to the actual LCD appliances which are made thin and in which the light diffusion distance is reduced from a little less than 20 mm to between 7 and 13 mm.

As is clear from FIG. 3 and FIG. 4 there is a relation between the luminescent lamp interval p, the length e from a vertical direction edge of the LCD panel 3 to a nearest luminescent lamp from the vertical direction edge, the number of the luminescent lamps N and the backlight vertical direction length L, which is indicated by the following equation (3),

N=(L−2×e)/p+1 (3)

Then the following inequality (4) is derived by substituting the equation (3) into the aforementioned inequalities (1) and (2).

N≧{L−(3.2×D+8)}/(1.34×D+9)+1 (4)

How the present embodiment is applied to LCD appliances of 32 inch size, 37 inch size and 42 inch size, in each of which the lighting system is made thin and the light diffusion distance is reduced to between 7 and 13 mm, is to be explained.

Firstly an application of the present embodiment to the 32 inch size LCD appliance is explained. The backlight vertical direction length L is 398 mm for the 32 inch size LCD appliance. If the light diffusion distance D is set to 9.3 mm, the luminescent lamp interval p, the length e from the vertical direction edge of the backlight unit to the nearest luminescent lamp 2 from the vertical direction edge and the number of the luminescent lamps N are determined to be respectively p≦21.46 mm, e≦18.88 mm, N≧17.79 according to inequalities (1), (2) and (4). Accordingly the brightness irregularity on the 32 inch size LCD appliance is prevented, for instance, by setting the number of the luminescent lamps N to 18, the luminescent lamp interval p to 21.4 mm and the length e to 17.1 mm.

Secondly an application of the present embodiment to the 37 inch size LCD appliance is explained. The backlight vertical direction length L is 467.4 mm for the 37 inch size LCD appliance. If the light diffusion distance D is set to 10 mm, the luminescent lamp interval p, the length e from the vertical direction edge of the backlight unit to the nearest luminescent lamp from the vertical direction edge and the number of the luminescent lamps N are determined to be respectively p≦22.4 mm, e≦20.0 mm, N≧20.1 according to inequalities (1), (2) and (4). Accordingly the brightness irregularity on the 37 inch size LCD appliance is prevented, for instance, by setting the number of the luminescent lamps N to 21, the luminescent lamp interval p to 22 mm and the length e to 13.7 mm.

Finally an application of the present embodiment to the 42 inch size LCD appliance is explained. The backlight vertical direction length L is 524 mm for the 42 inch size LCD appliance. If the light diffusion distance D is set to 11 mm, the luminescent lamp interval p, the length e from the vertical direction edge of the backlight unit to the nearest luminescent lamp from the vertical direction edge and the number of the luminescent lamps N are determined to be respectively p≦23.74 mm, e≦21.6 mm, N≧21.25 according to inequalities (1), (2) and (4). Accordingly the brightness irregularity on the 37 inch size LCD appliance is prevented, for instance, by setting the number of the luminescent lamps N to 22, the luminescent lamp interval p to 23 mm and the length e to 20.5 mm.

What is claimed:

1. A liquid crystal display appliance comprising a liquid crystal display panel for displaying a picture image and a lighting system for emitting light incident onto the liquid crystal display panel,
the lighting system being attached on a back side of the liquid crystal display panel and comprising:
a plurality of linearly elongated light sources each of which is disposed substantially in parallel with a display horizontal direction of the liquid crystal display panel,
a light reflector member for reflecting the light emitted from the linearly elongated light sources as well as diffusing the light, the light reflector member attached on a back side of the linearly elongated light sources, and
a light diffusing-transmission member for transmitting and diffusing the light, the light diffusing-transmission sheet disposed between the liquid crystal display panel and the linearly elongated light sources,
wherein a distance D between the light reflector member and the light diffusing-transmission member is between 7 and 13 mm,
wherein an interval p between the adjacent linearly elongated light sources and the distance D satisfy an first inequality, p≦1.34×D+9, and
wherein a length e between a vertical direction edge of the light reflector member and a nearest linearly elongated light source from the vertical direction edge and the distance D satisfy a second inequality, e≦1.6×D+4.

2. The liquid crystal display appliance according to claim 1, wherein the light diffusing-transmission member has a surface patterned with a concavo-convex shape which faces the liquid crystal display panel.

3. The liquid crystal display appliance according to claim 1, further comprising a set of optical sheets disposed between the light diffusing-transmission member and the liquid crystal display panel, which include at least two light diffusing sheets and one light collection film.

4. The liquid crystal display appliance according to claim 3, wherein the optical sheets include further include at least one light diffusing sheet or one light polarizing reflection film in addition to the two optical sheet and the one light collection film.

5. The lighting system comprising
a plurality of linearly elongated light sources each of which emits light and is disposed substantially in parallel with a display horizontal direction of the liquid crystal display panel,
a light reflector member for reflecting the light emitted from the linearly elongated light sources as well as diffusing the light, the light reflector member attached on a back side of the linearly elongated light sources, and
a light diffusing-transmission member for transmitting and diffusing the light, the light diffusing-transmission sheet disposed between the liquid crystal display panel and the linearly elongated light sources,
wherein a distance D between the light reflector member and the light diffusing-transmission member is between 7 and 13 mm,
wherein an interval p between the adjacent linearly elongated light sources and the distance D satisfy an first inequality, p≦1.34×D+9, and
wherein a length e between a vertical direction edge of the light reflector member and a nearest linearly elongated light source from the vertical direction edge and the distance D satisfy a second inequality, e≦1.6×D+4.
